(19) United States
(12) Patent Application Publication
(10) Pub. No.: US 2018/0339569 A1
(43) Pub. Date: Nov. 29, 2018

(54) MODULAR METAL HEATING PANEL FOR RAILCAR

(71) Applicant: Thermon Heating Systems, Edmonton (CA)

(72) Inventors: David Ross TenEycke, Oakville (CA); Bernard C. Moore, Edmonton (CA)

(21) Appl. No.: 15/987,485

(22) Filed: May 23, 2018

Related U.S. Application Data
(60) Provisional application No. 62/509,879, filed on May 23, 2017.

(51) Int. Cl. B60H 1/00; B61D 27/00; B61D 17/18; B61D 17/12; B61D 17/10; B61D 17/08

(52) U.S. Cl. CPC B60H 1/00271; B61D 27/0045; B61D 17/18; B61D 17/06; B61D 17/10; B61D 17/08; B61D 17/12

(57) ABSTRACT

A modular metal heating panel for a railcar includes a metal layer having a first surface for transferring heat into an interior space of the railcar. The metal layer also has a second surface. The heating panel includes a first adhesive layer disposed on the second surface of the metal layer and an electrical insulation layer bonded to the metal layer by the first adhesive layer. The heating panel also includes a heating element embedded within the electrical insulation layer. The heating panel further includes a second adhesive layer disposed on the electrical insulation layer for detachably bonding the heating panel to a structural panel of the railcar.

### CROSS-REFERENCE TO RELATED APPLICATION

This application claims priority to U.S. Provisional Patent Application No. 62/509,879 filed May 23, 2017, and entitled MODULAR METAL HEATING PANEL FOR RAILCAR, which is herein incorporated by reference in its entirety.

### TECHNICAL FIELD

The present invention relates generally to heaters for railcars and more specifically to modular heating panels for railcars.

### BACKGROUND

Railcars, such as light rail transit (LRT), subway, tram or other such passenger train cars, have been traditionally heated by either a heater core in an air conditioning unit or by small individual heat sources (unit heaters or baseboard heaters) disposed inside the railcar, e.g. under the seats, inside the walls or against the walls.

More recently, some railcars have embedded heating elements inside structural panels of the railcar to provide heated floors, walls and ceilings to replace or supplement the heating sources mentioned above. Some examples are disclosed in U.S. Pat. No. 8,329,278 (Kober et al.) and U.S. Pat. No. 8,796,588 (Berger). Integrating a heat source into a structural panel decreases weight and eliminates the unit heaters that would otherwise occupy space inside the railcar. However, replacement of damaged or faulty panels is problematic because the entire structural floor has to be removed to replace one faulty heating element. Furthermore, since the heat source is integrated into the panel, heat is generally distributed in all directions which, in many instances, results in an inefficient transfer of heat to areas where heat is not desired.

In view of these shortcomings, it would be highly desirable to improve the technology for heating railcars.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

In general, the present invention provides a modular metal heating panel for railcars. The heating panel is modular and also detachable to facilitate installation and servicing. The heating panel includes a rigid metal layer to promote uniform heat transfer while also protecting the heating element within the panel.

Accordingly, one inventive aspect of the present disclosure is a modular metal heating panel for a railcar. The heating panel includes a metal layer having a first surface for transferring heat into an interior space of the railcar. The metal layer also has a second surface. The heating panel includes a first adhesive layer disposed on the second surface of the metal layer and an electrical insulation layer bonded to the metal layer by the first adhesive layer. The heating panel also includes a heating element embedded within the electrical insulation layer. The heating panel further includes a second adhesive layer disposed on the electrical insulation layer for detachably bonding the heating panel to a structural panel of the railcar.

Another inventive aspect of the present disclosure is a method of heating a railcar. The method entails installing in the railcar a modular metal heating panel that comprises a metal layer having a first surface for transferring heat into an interior space of the railcar, wherein the metal layer also has a second surface, a first adhesive layer disposed on the second surface of the metal layer, an electrical insulation layer bonded to the metal layer by the first adhesive layer, a heating element embedded within the electrical insulation layer, and a second adhesive layer disposed on the electrical insulation layer for detachably bonding the heating panel to a structural panel of the railcar. The method further entails heating the railcar by powering the heating element.

Yet another inventive aspect of the present disclosure is a railcar comprising a chassis to which are attached a plurality of rail-engaging wheels and a passenger compartment supported by the chassis, the passenger compartment having a floor, walls and a ceiling defining an interior space. The railcar includes at least one modular metal heating panel comprising a metal layer having a first surface for transferring heat into an interior space of the railcar, wherein the metal layer also has a second surface, a first adhesive layer disposed on the second surface of the metal layer, an electrical insulation layer bonded to the metal layer by the first adhesive layer, a heating element embedded within the electrical insulation layer, and a second adhesive layer disposed on the electrical insulation layer for detachably bonding the heating panel to a structural panel of the railcar.

### BRIEF DESCRIPTION OF THE DRAWINGS

Further features and advantages of the present invention will become apparent from the following detailed description, taken in combination with the appended drawings in which:

FIG. 1 is a top view of a railcar having a plurality of heating panels in accordance with an embodiment of the present invention.

FIG. 2 is a cross-sectional view of the railcar of FIG. 1 showing the heating panels used on the floor, walls and ceiling in accordance with another embodiment.

FIG. 3 is a cross-sectional view of a heating panel in accordance with another embodiment of the present invention.

FIG. 4 is a top view of a heating panel in accordance with another embodiment.

FIG. 5 is a top view of a serpentine heating element for use in the heating panel.

FIG. 6 is a top view of a parallel layout of heating elements disposed between bus strips that may be used in the heating panel.

FIG. 7 is a top view of a grid-type arrangement of heating elements that may be used in the heating panel.

FIG. 8 is an angled grid-type arrangement of heating elements that may be used in the heating panel.

FIG. 9 is a top view of a parallel arrangement of heating elements controlled by a thermostat.

FIG. 10 is a top view of a series arrangement of heating elements controlled by a thermostat.

FIG. 11 is a top view of an arrangement of heating elements modulated by a microcontroller.

FIG. 12 is a top view of an arrangement of heating elements individually controlled in heating zones by a microcontroller.

It will be noted that throughout the appended drawings, like features are identified by like reference numerals.

### DETAILED DESCRIPTION

Disclosed herein is a novel modular metal heating panel for a railcar. Various embodiments of the modular metal heating panel are described with reference to the figures. The modular metal heating panel (also referred to herein as simply the “heating panel”) may be used in various types of railcars or in analogous ground transit vehicles. The term “railcar” shall be construed to mean any rail vehicle for carrying passengers. The railcar may be a light rail transit (LRT) car, a subway car, a tram car or any other such passenger train car.

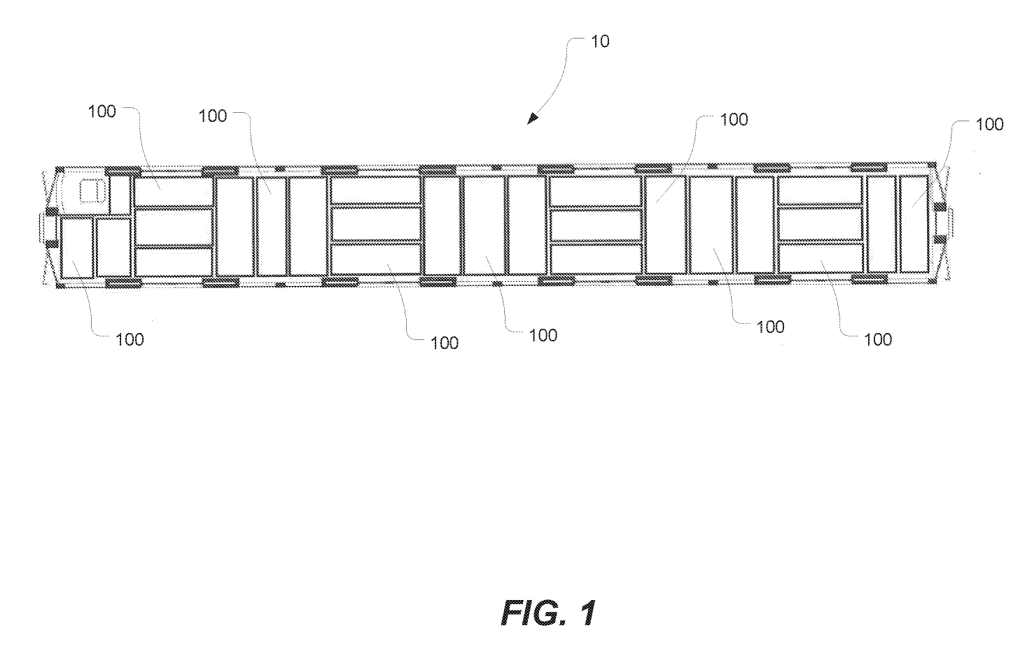

FIG. 1 is a top view of an example railcar denoted by reference numeral 10 in which the novel heating panels 100 may be installed. The railcar 10 has a chassis 20 to which are attached a plurality of rail-engaging wheels 30. The railcar 10 has a passenger compartment 40 supported by the chassis 20, the passenger compartment having a floor, walls and a ceiling defining an interior space 50. In the example of FIG. 1, the railcar 10 has a plurality of heating panels 100 that substantially cover all of the floor. However, in other embodiments, the heating panels 100 may be used only on a portion of the floor. In an extreme case, there may be only a single heating panel 100 in the railcar 10. The heating panels 100 shown in FIG. 1 are rectangular. However, in other embodiments, they may have other shapes.

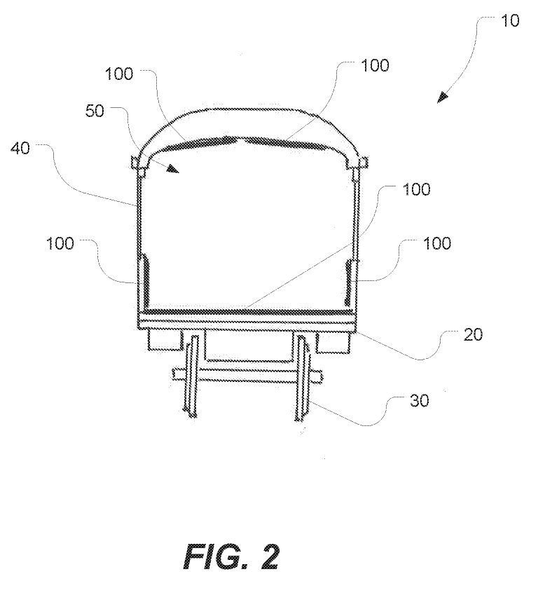

FIG. 2 is a cross-sectional view of the railcar 10 of FIG. 1 showing the heating panels 100 used on the floor, walls and ceiling. It will be appreciated that the heating panels 100 may be used in any desired combination (floor and walls, floor and ceiling, walls and ceiling) or only on the floor, only on the walls, or only on the ceiling.

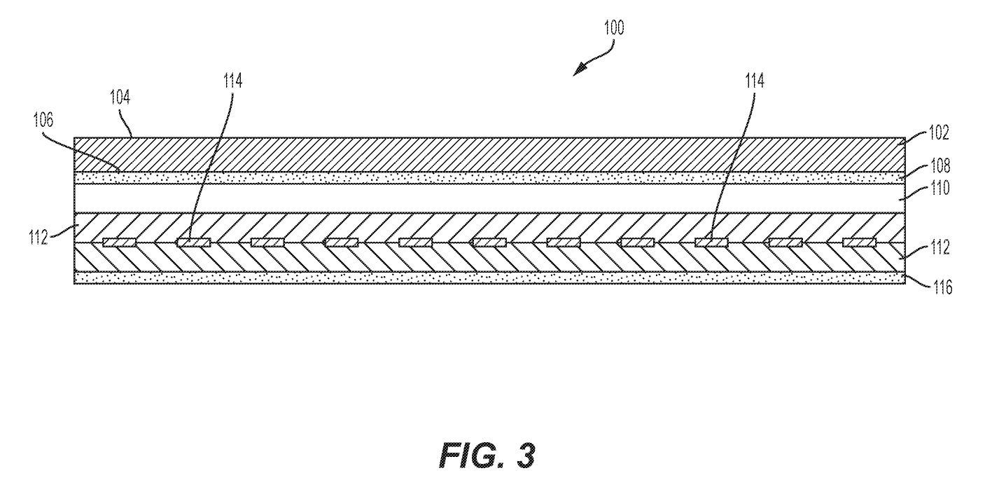

FIG. 3 is a cross-sectional view of a heating panel 100 in accordance with an embodiment of the present invention.

In the embodiment shown in FIG. 3, the heating panel 100 includes a metal layer 102 having a first surface 104 for transferring heat into an interior space of the railcar. The metal layer 102 also has a second surface 106. As shown by way of example in FIG. 3, the heating panel 100 includes a first adhesive layer 108 disposed on the second surface 106 of the metal layer 102. As further shown in FIG. 3, one or more electrical insulation layers 110, 112 is bonded to the metal layer 102 by the first adhesive layer 108. A heating element 114 is embedded within the electrical insulation layer(s), more specifically the insulation layer 112 as shown in the figure. A second adhesive layer 116 is disposed on the electrical insulation layer 112 for detachably bonding the heating panel 100 to a structural panel of the railcar.

In the embodiment of FIG. 3, there may be a single heating element 114 or a plurality of heating elements 114.

In the embodiment of FIG. 3, the heating element 114 may be an electrically resistive wire connected to an electrical power supply of the railcar to generate heat within the heating panel. The electrically resistive wire or etching is electrically insulated in an electrical insulation layer formed of an electrically insulating material such as silicone, rubber, polyamide like Kapton®, polyester or any other suitable insulation.

In the embodiment of FIG. 3, the metal layer 102 is a rigid metal layer of uniform thickness. If the heating panel 100 is to be used on the floor of the railcar 10, it should be sufficiently thick to support the dynamic and static loading of passengers standing and walking on the panel 100.

The metal layer 102 has a dual function. The metal layer 102 not only promotes uniform heat transfer but also protects the heating element 114 within the panel 100. In other words, the metal layer 102 provides protection to the heat source (heating element 114) and is also an effective heat sink. The metal layer 102 when in full operation would be warm to the touch and would effectively warm the interior space 50 of the railcar 10. Because the metal layer 102 is a heat sink, the heating efficiency of the panel 100 is greater than prior-art designs known to the inventors.

The heating panel 100 of FIG. 3 is a modular detachable panel. The heating panel 100 is detachably bonded to one or more of the structural panels using a tacky adhesive layer that enables non-destructive separation of the heating panel from the structural panel(s) of the railcar 10 to which it is bonded. Thus, unlike the prior art, each individual heating panel 100 can be removed or detached from the structural panel for maintenance, repair or replacement, e.g. by simply prying off the old panel and attaching a new panel. Alternatively, if the panel is to be repaired, refurbished or serviced, adhesive may be reapplied to the panel to enable the panel to be re-bonded to the structural panel. This obviates the need to remove or replace the entire structural panel if an embedded heating element ceases to function or requires maintenance. Because the heating panels are modular, only the affected heating panel has to be removed. A new, refurbished or repaired heating panel can be easily and quickly installed by virtue of the panel's modularity.

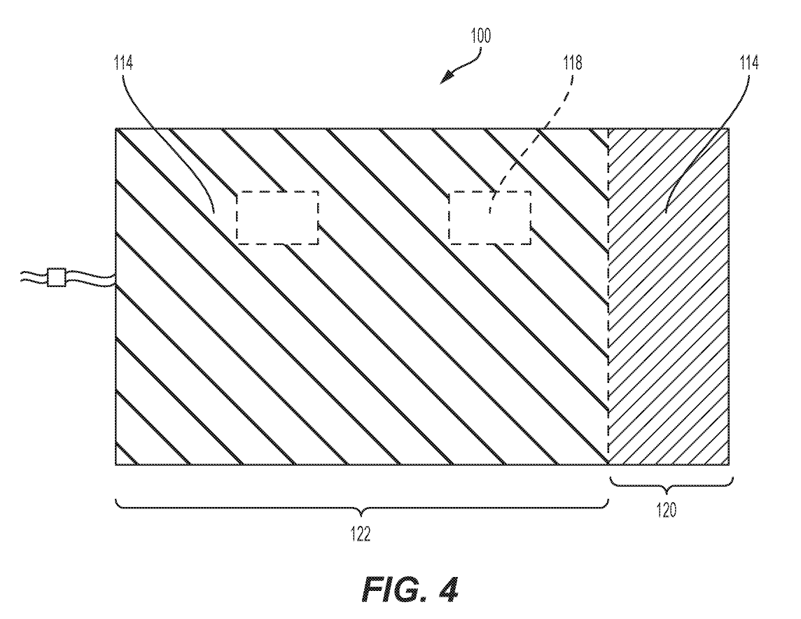

In another embodiment, which is depicted in FIG. 4, the heating element 114 has a first area 120 of higher power density and a second area 122 of lower power density. As shown in FIG. 4, this may be done by varying the amount of resistive wire per unit area in different portions of the panel. Various heat densities can thus be designed into each panel allowing a variability of heat across a particular panel. For example, a panel's edge that is closer to a wall or door could have a higher heat output than the portions of the panel that are further away from the wall or door. Other areas 118 may be included which have no heated area to allow for penetrations for mounting seats or support poles.

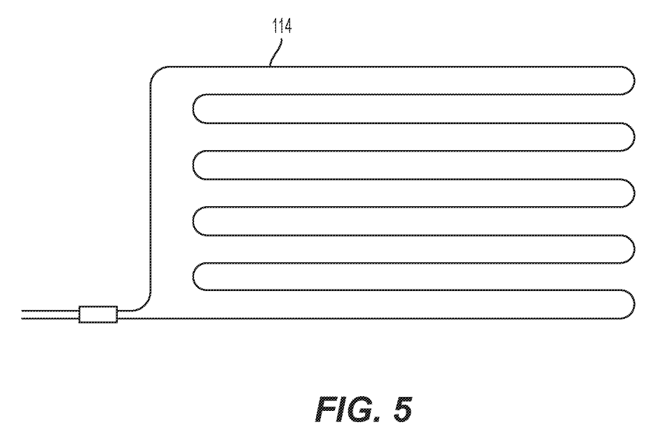

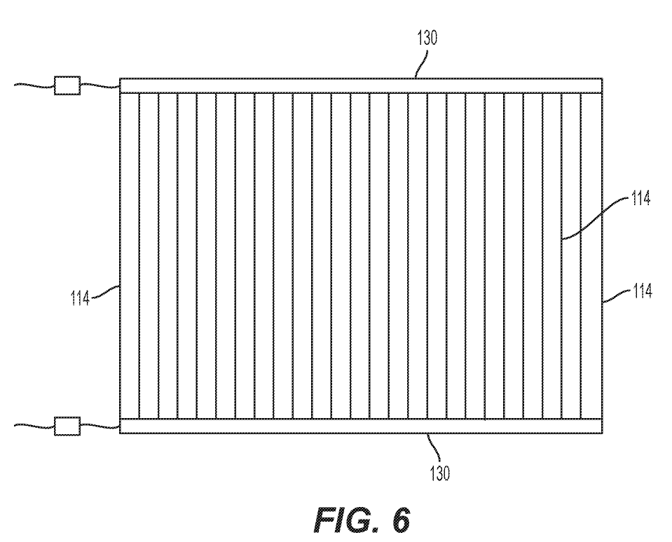

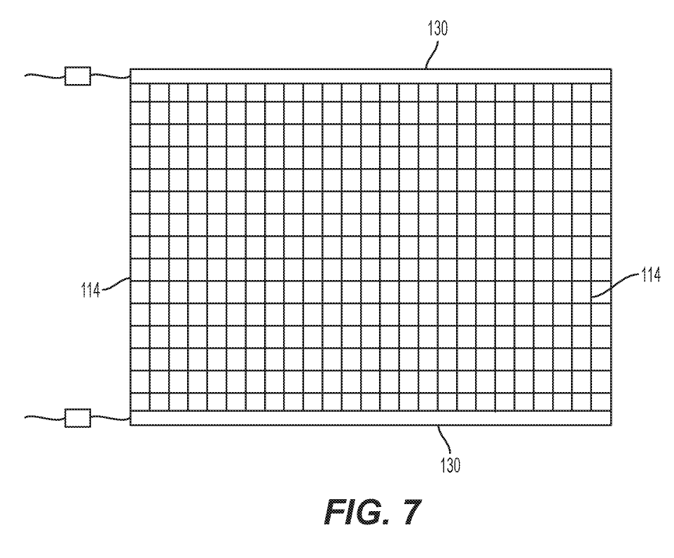

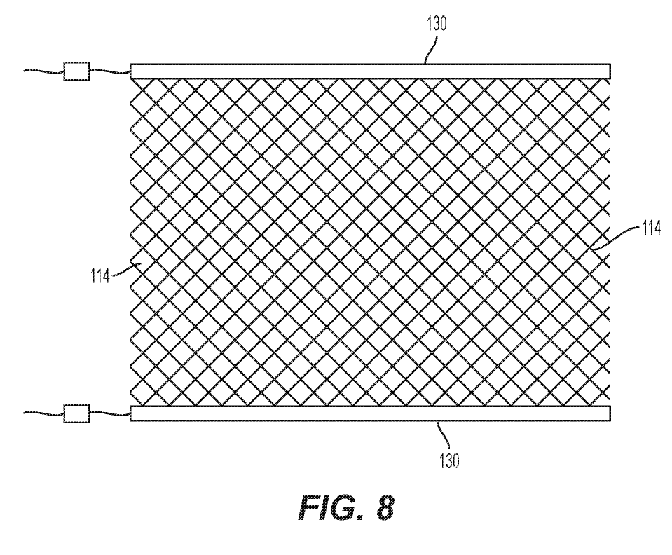

Various types and arrangements of heating elements 114 may be used inside the heating panel. For example, FIG. 5 shows a serpentine heating element 114 for use in the heating panel. As another example, FIG. 6 shows a parallel layout of heating elements 114 disposed between bus strips 130 (or bus conductors) that may be used in the heating panel. As a further example, FIG. 7 shows a grid-type arrangement (i.e. a mesh) of heating elements 114 between bus strips 130 that may be used in the heating panel. As yet a further example, FIG. 8 shows an angled grid-type arrangement of heating elements 114 between bus strips 130 that may be used in the heating panel. Other arrangements may also be used. The heating elements 114 may be made of electrically resistive wire. The heating elements 114 may alternatively be made by etching techniques to leave behind a heat-generating metal circuit.

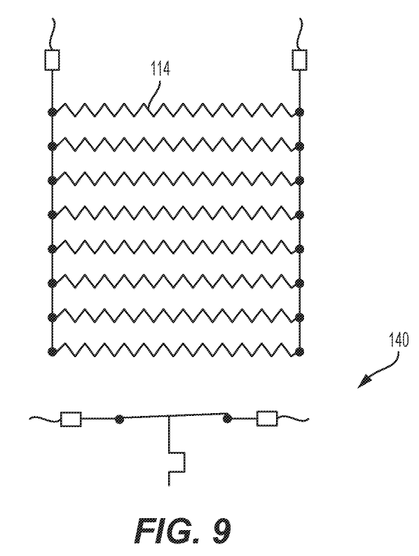

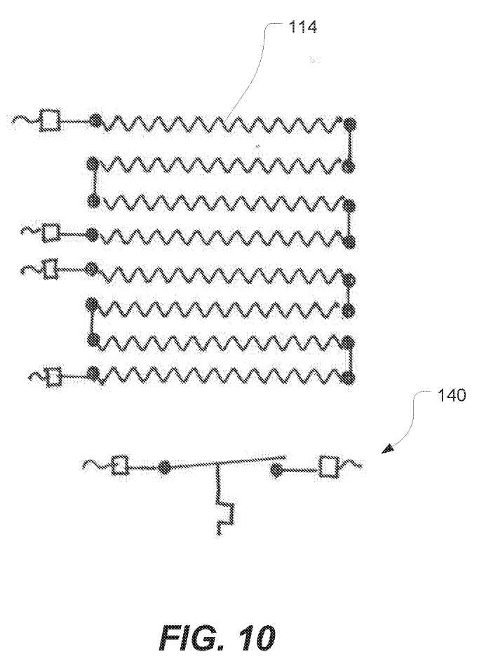

In some embodiments, the heating panel includes a thermostat. FIG. 9 is a top view of a parallel arrangement of heating elements 114 controlled by one or more thermostat(s) 140. FIG. 10 is a top view of a series arrangement of heating elements 114 controlled by a thermostat 140.

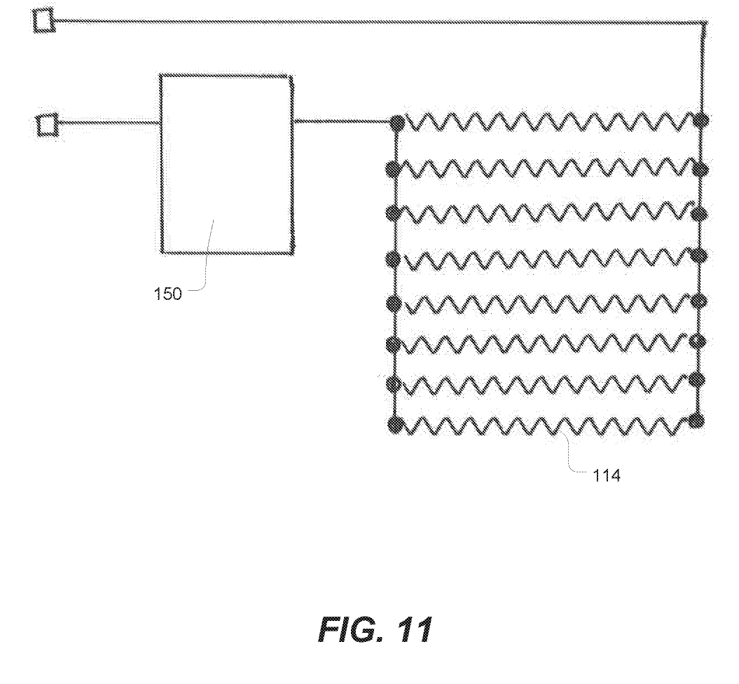

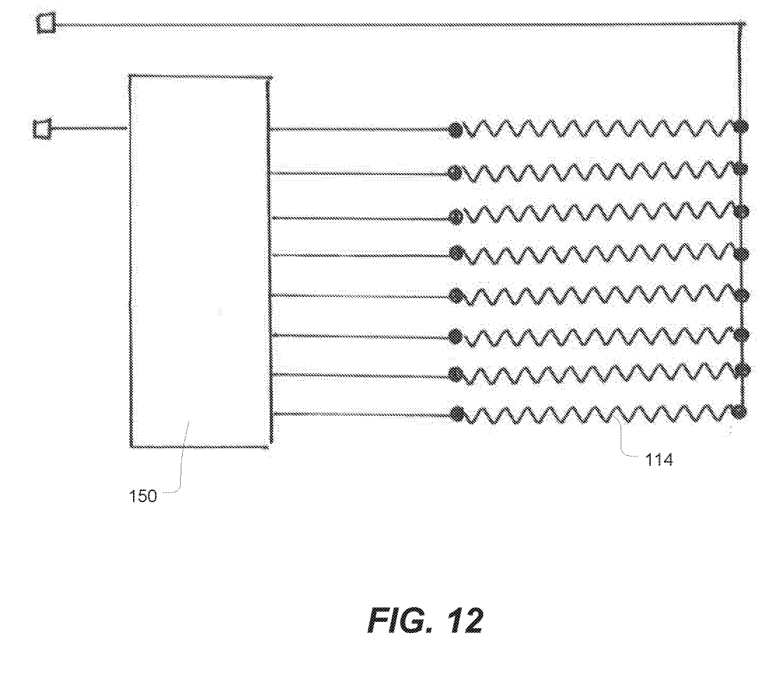

In some other embodiments, the heating panel includes a microcontroller. FIG. 11 is a top view of an arrangement of heating elements 114 controlled by a modulating microcontroller 150. FIG. 12 is a top view of an arrangement of heating elements 114 individually controlled in heating zones by a microcontroller 150.

This novel heating panel enables a novel method of heating a railcar. Accordingly, another aspect of the invention is a method of heating a railcar. The method entails installing in the railcar a modular metal heating panel. The heating panel comprises a metal layer having a first surface for transferring heat into an interior space of the railcar, wherein the metal layer also has a second surface, a first adhesive layer disposed on the second surface of the metal layer, an electrical insulation layer bonded to the metal layer by the first adhesive layer, a heating element embedded within the electrical insulation layer, and a second adhesive layer disposed on the electrical insulation layer for detachably bonding the heating panel to a structural panel of the railcar. The method further entails heating the railcar by powering the heating element.

In one implementation of the method, the step of installing the modular metal heating panel entails installing the modular metal heating panel in a floor of the railcar. In another implementation of the method, the step of installing the modular metal heating panel entails installing the modular metal heating panel in a wall of the railcar. In one implementation of the method, the step of installing the modular metal heating panel entails installing the modular metal heating panel in a ceiling of the railcar.

Yet another inventive aspect is a railcar that has a chassis to which are attached a plurality of rail-engaging wheels and a passenger compartment supported by the chassis, the passenger compartment having a floor, walls and a ceiling defining an interior space. The railcar is characterized by at least one modular metal heating panel comprising a metal layer having a first surface for transferring heat into an interior space of the railcar, wherein the metal layer also has a second surface, a first adhesive layer disposed on the second surface of the metal layer, an electrical insulation layer bonded to the metal layer by the first adhesive layer, a heating element embedded within the electrical insulation layer and a second adhesive layer disposed on the electrical insulation layer for detachably bonding the heating panel to a structural panel of the railcar.

In one embodiment of the railcar, the heating panel is on the floor. In another embodiment of the railcar, the heating panel is on one or more of the walls. In another embodiment of the railcar, the heating panel is on the ceiling.

In one embodiment of the railcar, the heating element has a first area of higher power density and a second area of lower power density.

In one embodiment of the railcar, the heating panel is rectangular. As noted above, other shapes may be used.

In one embodiment of the railcar, the metal layer is a rigid metal layer of uniform thickness.

In one embodiment of the railcar, the heating panel comprises a thermostat.

In one embodiment of the railcar, the heating panel comprises a microcontroller.

In one embodiment of the railcar, the floor is substantially covered by a plurality of heating panels which may be configured as shown in FIG. 1 to provide a tile-like matrix of panels covering substantially the whole floor. As mentioned above, in other embodiments, in addition to the floor, the panels may cover all or part of the ceiling and walls of the railcar.

This invention has been described in terms of specific embodiments, implementations and configurations which are intended to be exemplary only. Persons of ordinary skill in the art will appreciate, having read this disclosure, that many obvious variations, modifications and refinements may be made without departing from the inventive concept(s) presented herein. The scope of the exclusive right sought by the Applicant(s) is therefore intended to be limited solely by the appended claims.

1. A modular metal heating panel for a railcar, the heating panel comprising:
a metal layer having a first surface for transferring heat into an interior space of the railcar, wherein the metal layer also has a second surface;
a first adhesive layer disposed on the second surface of the metal layer;
an electrical insulation layer bonded to the metal layer by the first adhesive layer;
a heating element embedded within the electrical insulation layer; and
a second adhesive layer disposed on the electrical insulation layer for detachably bonding the heating panel to a structural panel of the railcar.

2. The heating panel of claim 1 wherein the heating element has a first area of higher power density and a second area of lower power density.

3. The heating panel of claim 1 wherein the heating panel is rectangular.

4. The heating panel of claim 1 wherein the metal layer is a rigid metal layer of uniform thickness.

5. The heating panel of claim 1 comprising a thermostat.

6. The heating panel of claim 1 comprising a microcontroller.

7. A method of heating a railcar, the method comprising:
installing in the railcar a modular metal heating panel that comprises:
a metal layer having a first surface for transferring heat into an interior space of the railcar, wherein the metal layer also has a second surface;
a first adhesive layer disposed on the second surface of the metal layer;
an electrical insulation layer bonded to the metal layer by the first adhesive layer;
a heating element embedded within the electrical insulation layer;
a second adhesive layer disposed on the electrical insulation layer for detachably bonding the heating panel to a structural panel of the railcar. heating the railcar by powering the heating element.

8. The method of claim 7 wherein installing the modular metal heating panel entails installing the modular metal heating panel in a floor of the railcar.

9. The method of claim 7 wherein installing the modular metal heating panel entails installing the modular metal heating panel in a wall of the railcar.

10. The method of claim 7 wherein installing the modular metal heating panel entails installing the modular metal heating panel in a ceiling of the railcar.

11. A railcar comprising:
a chassis to which are attached a plurality of rail-engaging wheels;
a passenger compartment supported by the chassis, the passenger compartment having a floor, walls and a ceiling defining an interior space.
at least one modular metal heating panel comprising:
a metal layer having a first surface for transferring heat into an interior space of the railcar, wherein the metal layer also has a second surface;
a first adhesive layer disposed on the second surface of the metal layer;
an electrical insulation layer bonded to the metal layer by the first adhesive layer;
a heating element embedded within the electrical insulation layer;
a second adhesive layer disposed on the electrical insulation layer for detachably bonding the heating panel to a structural panel of the railcar.

12. The railcar of claim 11 wherein the heating panel is on the floor.

13. The railcar of claim 11 wherein the heating panel is on one or more of the walls.

14. The railcar of claim 11 wherein the heating panel is on the ceiling.

15. The railcar of claim 11 wherein the heating element has a first area of higher power density and a second area of lower power density.

16. The railcar of claim 11 wherein the heating panel is rectangular.

17. The railcar of claim 11 wherein the metal layer is a rigid metal layer of uniform thickness.

18. The railcar of claim 11 wherein the heating panel comprises a thermostat.

19. The railcar of claim 11 wherein the heating panel comprises a microcontroller.

20. The railcar of claim 11 wherein the floor is substantially covered by a plurality of heating panels.
